(19) United States
(12) Patent Application Publication
(10) Pub. No.: US 2012/0132504 A1
(43) Pub. Date: May 31, 2012

(54) CONVEYOR FOR DRILL CUTTINGS

(75) Inventors: Chad Ardoin, Scott, LA (US); Dean Bidstrup, Lafayette, LA (US); Richard Guillory, Broussard, LA (US); Opie Prados, Lafayette, LA (US); Damon Pugh, Scott, LA (US)

(73) Assignee: M-I L.L.C., Houston, TX (US)

(21) Appl. No.: 13/173,446

(22) Filed: Jun. 30, 2011

Related U.S. Application Data
(60) Provisional application No. 61/360,311, filed on Jun. 30, 2010.

(51) Int. Cl. B65G 33/32; B65G 33/00

(52) U.S. Cl. 198/672; 198/657

(57) ABSTRACT

A conveyor for drill cuttings includes a plurality of serially-aligned augers, wherein each auger has two opposed ends, a flex coupling secured between a first end of one auger and a second end of an adjacent subsequent auger, a trough at least partially surrounding each auger, a motor coupled to one end of the series of augers and providing rotation to the end of the series of augers, and at least one hangar bearing retaining each auger within the trough, wherein a first angle is present between two of the augers, said flex coupling transferring the rotation from the motor across the angle between the two augers.

### CROSS-REFERENCE TO RELATED APPLICATIONS

This application claims the benefit of the following application under 35 U.S.C. 119 (e); U.S. Provisional Application Ser. No. 61/360,311 filed on Jun. 30, 2010, incorporated by reference in its entirety herein.

### BACKGROUND OF INVENTION

1. Field of Invention

Embodiments disclosed herein generally relate to a conveyor for drill cuttings. More specifically, embodiments disclosed herein describe a flexible auger system for transporting cutting between two points on a drill rig or in another location.

2. Background Art

The installation of waste management and solids control equipment at drilling sites often calls for the need of auger conveyor systems. Depending on the type of rig, these systems can become very complex, requiring the use of multiple drives and many sections of auger to overcome obstacles. This additional equipment provides extra rental costs to the customer. Further, the additional equipment increases the amount of time required for installation, the amount of maintenance that will be required, and the amount of power consumed in running the equipment.

Current conveyor systems on drilling rigs typically include one or more linear sections of auger. When the cuttings need to be conveyed in a different direction, they are dropped onto another linear section of auger (See FIG. 1). This system has several disadvantages. One disadvantage is that there is an increased risk of cuttings falling outside of the conveyance system onto the floor, other equipment, or even onto personnel at that rig site. Another disadvantage is that each linear section of auger requires its own motor to rotate the auger and convey the cuttings. Further, the additional equipment requires additional costs to rent or buy as well as to maintain.

Accordingly, there exists a need for a system that can efficiently and effectively conveying cuttings between equipment on a drilling rig.

### SUMMARY

In one aspect, embodiments disclosed herein relate to a conveyor for drill cuttings including a plurality of serially-aligned augers, wherein each auger has two opposed ends, a flex coupling secured between a first end of one auger and a second end of an adjacent subsequent auger, a trough at least partially surrounding each auger, a motor coupled to one end of the series of augers and providing rotation to the end of the series of augers, and at least one hangar bearing retaining each auger within the trough, wherein a first angle is present between two of the augers, said flex coupling transferring the rotation from the motor across the angle between the two augers.

In another aspect, the embodiments disclosed herein relate to an apparatus for conveying wellbore drill cuttings includes a first auger, a second auger, and a flex coupling connecting the first auger and the second auger, wherein the first auger is at an angle with respect to the second auger.

Other aspects and advantages of the claimed subject matter will be apparent from the following description and the appended claims.

### DESCRIPTION OF THE DRAWINGS

FIG. 1 is a view of a prior art cuttings conveying system.

FIG. 2 is a view of a prior art cuttings conveying system.

FIG. 3 is a top view of a conveying system in accordance with embodiments disclosed herein.

FIG. 4 is a side view of a conveying system in accordance with embodiments disclosed herein.

FIG. 5 is a view of a conveying system in accordance with embodiments disclosed herein.

FIG. 6 is a top view of a flex coupling in accordance with embodiments disclosed herein.

FIG. 7 is a view of a disassembled portion of the conveying system in accordance with embodiments disclosed herein.

FIG. 8 is a view of a boot in accordance with embodiments disclosed herein.

FIG. 9 is a top view of a conveying system in accordance with embodiments disclosed herein.

### DETAILED DESCRIPTION

In one aspect, embodiments disclosed describe a conveyor for drill cuttings. More specifically, embodiments disclosed herein describe a flexible auger system for transporting cutting between two points on a drill rig or in another location.

Referring to FIG. 3, a conveyor 10 for drill cuttings is depicted. The conveyor includes two or more augers 12 that are aligned in series. Each auger 12 includes a shaft 22 and one or more flights 24. The shaft 22 of each auger 12 has a first end 26 and a second end 28. The first end 26 of each auger, aside from the auger 12 on the end of the series, is coupled, directly or indirectly, to the second end 28 of the adjacent auger 12.

A trough 14 at least partially surrounds the augers 12. The augers 12 are held within the trough 14 by one or more hangar bearings 16. A motor 18 is coupled to one end of the series of augers 12. The motor 18 is coupled, directly or indirectly, to the shaft 22 of an end of the first auger 12 in the series. The motor 18 imparts rotation to the shaft 22 of the first auger and the rotation is carried through the series of augers 12. As the shaft 22 is rotated, the flights 24 affixed to the shaft 22 push the cuttings along the trough 14 in the desired direction.

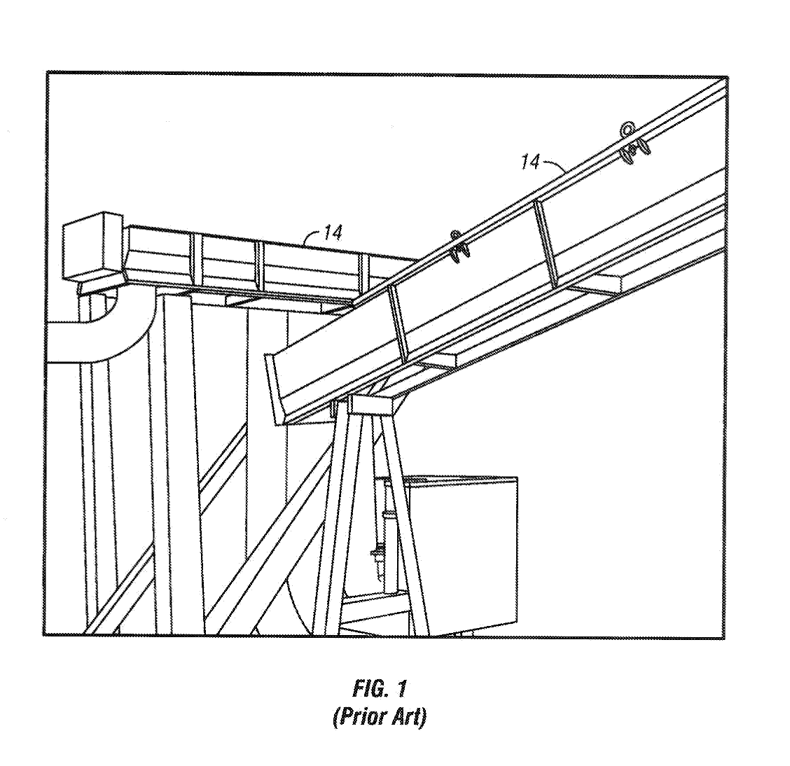

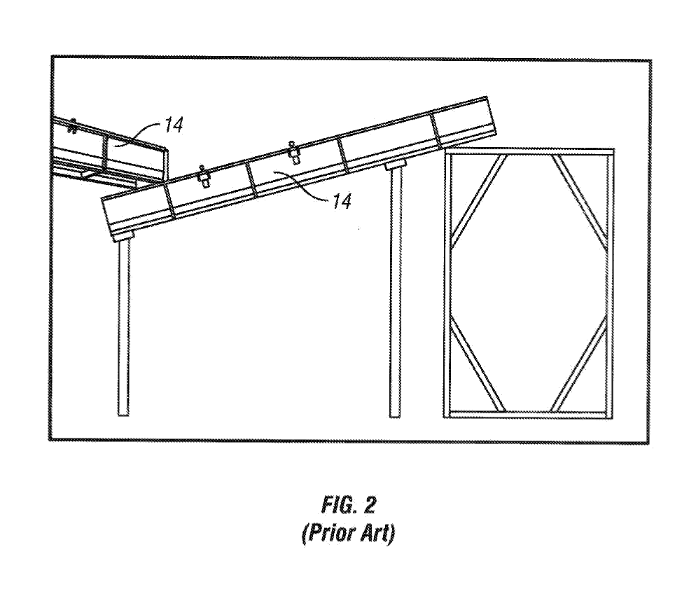

In the prior art systems depicted in FIGS. 1 and 2, when cuttings are to be moved in a direction different from the linear direction they are currently driven by the auger, the cuttings drop through an opening in the bottom of the trough 14 or at the end of the trough 14 onto another auger which is driven by another motor.

The new conveyor depicted in FIG. 3 includes a flex coupling 30 secured between a first end 26 of one auger 12 and a second end 28 of another auger 12. The flex coupling 30 is used to transmit the rotation imparted by the motor 16 on the first auger 12 through to at least one subsequent auger 12. The subsequent auger 12 may be at a first angle 32 with respect to the first auger 12. Thus, the cuttings may be conveyed through an angular turn rather than being dropped onto a subsequent set of augers to change the direction of conveyance. Advantageously, this reduces the risk of having cuttings dropped onto a rig floor or onto other equipment where they can cause slipping and/or contamination hazards.

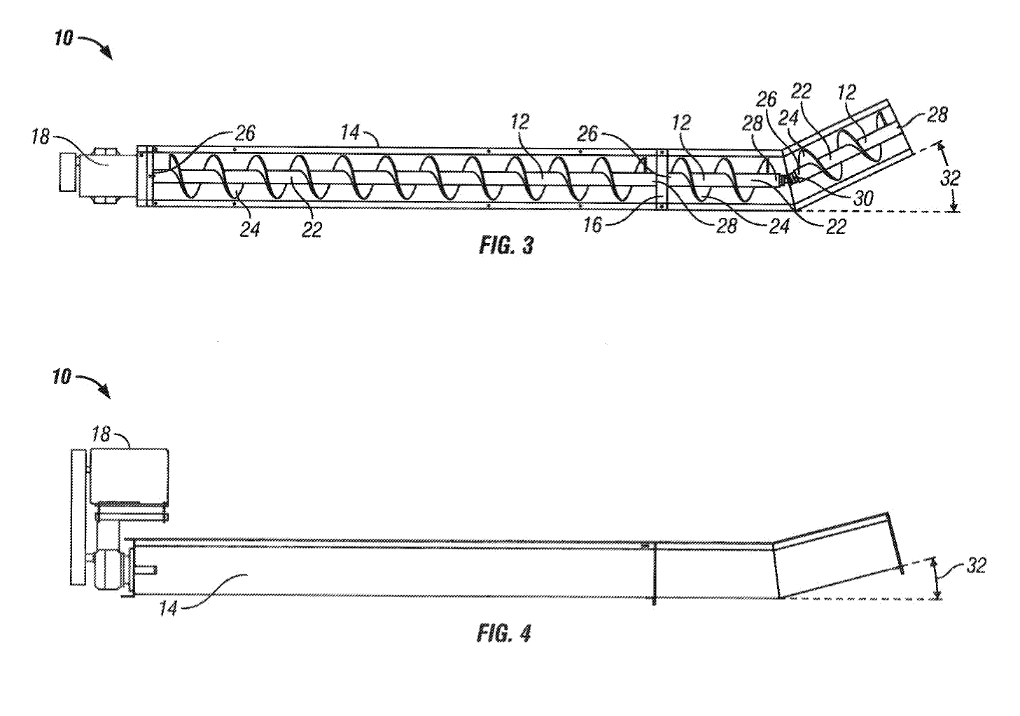

The first auger 12 and the second auger 12 may be oriented such that first angle 32 is horizontal as shown in FIG. 3, vertical as shown in FIG. 4, or a combination of both horizontal and vertical (not shown). The first angle 32 may be between 0.5° and 35° and is preferably between 1° and 25°.

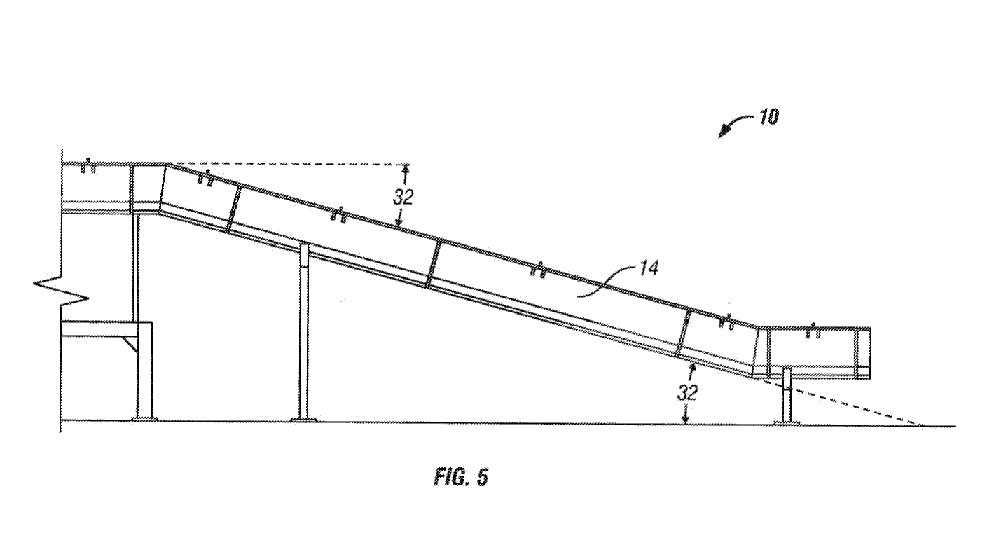

As shown in FIG. 5, there may be a first angle 32 and a second angle 34 in the same series of augers 12. The first angle 32 may be a horizontal angle, vertical angle, or a horizontal and vertical angle between the augers 12. The second angle may be a horizontal angle, vertical angle, or a horizontal and vertical angle between the augers 12. The angle direction of the first angle 32 does not affect the angle direction of the second angle 34. That is, the two angles 32, 34 are independent of each other and may be selected based on the needs of the conveyance system. There may be additional flex couplings 30 for transferring rotation to augers placed at additional angles.

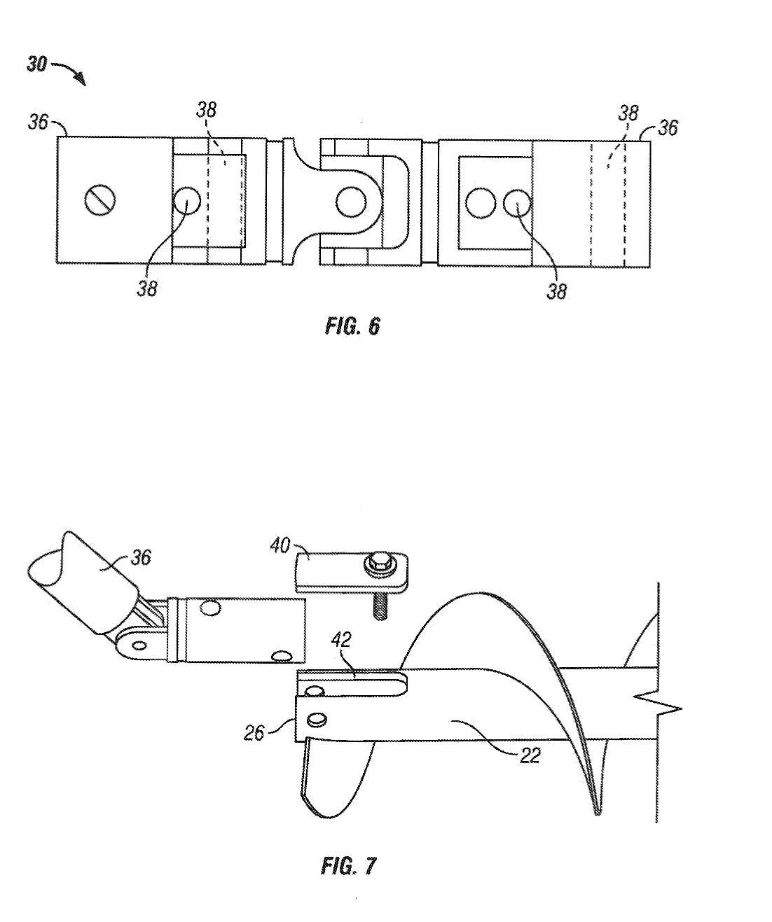

Referring to FIG. 6, the flex coupling 30 is depicted. The flex coupling 30 is a universal joint that can transmit rotation from one of its ends to the other even while the ends are at an angle less than 180°. The flex coupling 30 includes a yoke 36 on each end and at least one pin hole 38 on each end.

To secure the flex coupling 30 between two adjacent auger sections 12, the yoke 36 of each end is placed inside a hollow section of the first end 26 the auger shaft 22. Pressure pins (not shown) or bolts (not shown) or other similar attaching devices are used to secure the yoke 36 within the end 26.

Due to the sticky nature of drill cuttings, if a section of the auger 12 needs to be replaced, a mechanism for quickly and individually removing the offending section of auger 12 would be desired. To accomplish this, a detachable key 40 allows efficient removal of the auger 12. Referring to FIG. 7, each end 26, 28 of the auger shaft 22 has a cutout section 42 that is wide enough to receive the yoke 36 of the flex coupling 30. The key 40 is received by the cutout section 42 and a bolt or similar fastener is used to secure the detachable key 40 to the yoke 36. When the key 40 is positioned in the cutout section 42, the surface of the key 40 is flush with the surface of the auger shaft 22.

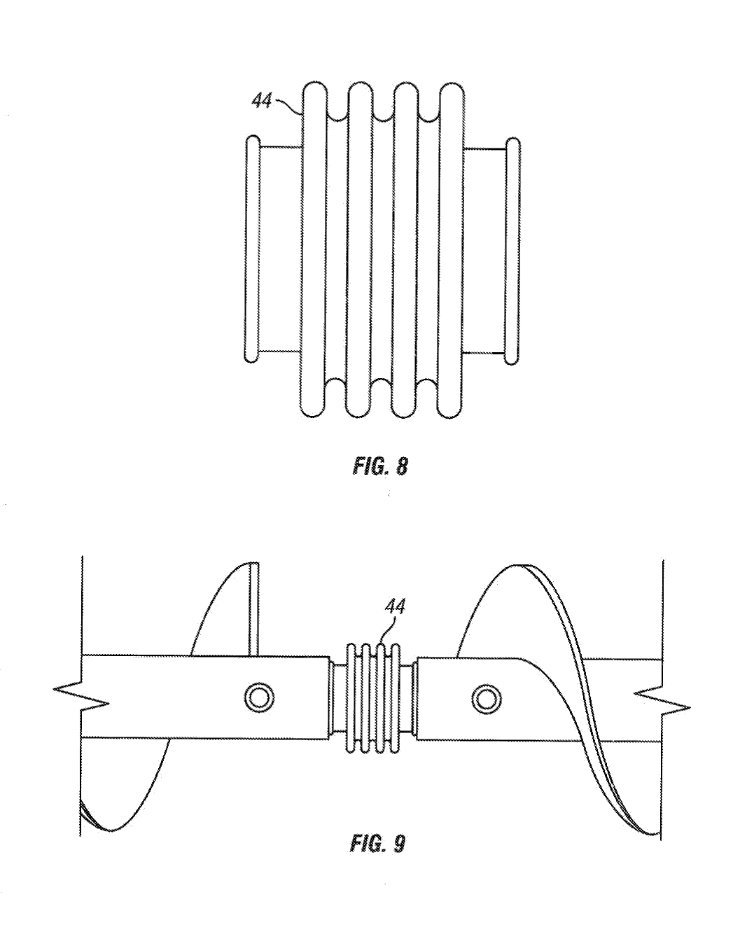

A flexible boot 44, shown in FIGS. 8 and 9, covers the flex coupling 30 to prevent cuttings from interfering with the function of the flex coupling 30. The boot 44 is made of a flexible material that is resistant to chemical degradation as the cuttings it is in contact with may be coated with various chemical compositions found in drilling fluids as well as fluids from the formation being drilled. The boot may be made from nitrile, Viton™ (available from DuPont), polyurethane, silicone, fluorsilicone rubber, or nylon or other similarly chemical-resistant material.

While the claimed subject matter has been described with respect to a limited number of embodiments, those skilled in the art, having benefit of this disclosure, will appreciate that other embodiments can be devised which do not depart from the scope of the claimed subject matter as disclosed herein. Accordingly, the scope of the claimed subject matter should be limited only by the attached claims.

What is claimed is:

1. A conveyor for drill cuttings comprising:
a plurality of serially-aligned augers, wherein each auger has two opposed ends;
a flex coupling secured between a first end of one auger and a second end of an adjacent subsequent auger;
a trough at least partially surrounding each auger;
a motor coupled to one end of the series of augers and providing rotation to the end of the series of augers;
at least one hangar bearing retaining each auger within the trough; and
wherein a first angle is present between two of the augers, said flex coupling transferring the rotation from the motor across the angle between the two augers.

2. The conveyor of claim 1, further comprising a flexible boot covering the flex coupling.

3. The conveyor of claim 2, wherein the flexible boot is made from a material selected from the group consisting of nitrile, Viton, polyurethane, silicone, fluorsilicone rubber, and nylon.

4. The conveyor of claim 1, wherein the first angle between the two augers is between 0.5° and 35°.

5. The conveyor of claim 1, wherein the first angle between the two augers is between 1° and 25°.

6. The conveyor of claim 1, wherein the first angle between the two augers is vertical.

7. The conveyor of claim 1, wherein the first angle between the two augers is horizontal.

8. The conveyor of claim 1, wherein the first angle between the two augers is vertical and horizontal.

9. The conveyor of claim 1, further comprising a second angle between two other augers in the series of augers.

10. The conveyor of claim 9, wherein the first angle is vertical and the second angle is horizontal.

11. The conveyor of claim 1, wherein each auger further comprises an auger shaft, said shaft having a hollow section on at least the opposing ends; and
wherein the flex coupling further comprises:
a yoke to which the auger is coupled;
at least one pressure pin retaining the yoke to the auger;
a detachable key for clamping the yoke within the hollow section of the auger shaft.

12. An apparatus for conveying wellbore drill cuttings comprising:
a first auger;
a second auger;
a flex coupling connecting the first auger and the second auger; and
wherein the first auger is at an angle with respect to the second auger.

13. The apparatus of claim 12 wherein the angle is horizontal.

14. The apparatus of claim 12 wherein the angle is vertical.

15. The apparatus of claim 12 wherein the angle is equal to or less than 25°.

16. The apparatus of claim 12 wherein the angle is equal to or less than 35°.

17. The apparatus of claim 12 wherein the flex coupling further comprises:
a yoke to which the first auger is coupled;
at least one pressure pin retaining the yoke to the auger;
a detachable key for clamping the yoke within a hollow section of a shaft of the first auger.

18. The apparatus of claim 12 further comprising a boot covering the flex coupling, wherein said boot is formed from a material comprising nitrile.

19. The apparatus of claim 12 further comprising a boot covering the flex coupling, wherein said boot is formed from a material comprising Viton.
